(19) United States
(12) Patent Application Publication
(10) Pub. No.: US 2017/0237305 A1
(43) Pub. Date: Aug. 17, 2017

(54) ELECTRIC GENERATOR

(71) Applicant: Bahram Raeen, Santa Monica, CA (US)

(72) Inventor: Bahram Raeen, Santa Monica, CA (US)

(21) Appl. No.: 15/515,543

(22) PCT Filed: Sep. 29, 2015
(86) PCT No.: PCT/US15/52961

§ 371 Date: Mar. 29, 2017

Related U.S. Application Data
(63) Continuation-in-part of application No. 14/608,101, filed on Jan. 28, 2015, now abandoned.
(60) Provisional application No. 62/058,019, filed on Sep. 30, 2014.

(51) Int. Cl. H02K 1/17; H02K 3/28

(52) U.S. Cl. CPC H02K 1/17; H02K 3/28; H02N 11/008

(57) ABSTRACT

An electric generator comprises a substantially flat magnet having a series of alternating north and south polarities, the magnet having an upper surface, a lower surface and opposing edges. A first metal plate formed on the upper surface of the magnet, and a second metal plate formed on the lower surface of the magnet. A pair of wires is connected to one of the first or second metal plates and an edge of the magnet, the pair of wires capturing for use energy or power produced by the electric generator.

### FIELD AND BACKGROUND OF THE INVENTION

This is invention relates to an electric generator. More particularly, the invention relates to an electric generator which utilizes magnets which are sandwiched by one or more selected layers of metals. The configuration and construction of the electric generator of the invention may produce a flow of mass particles, which can be controlled and harnessed, and whereby a charge flow is setup within the system which can be utilized for the extraction of power or energy to form the electric generator of the invention.

### SUMMARY OF THE INVENTION

According to one aspect of the invention, there is provided an electric generator comprising: a substantially flat magnet having a series of alternating north and south polarities, the magnet having an upper surface, a lower surface and opposing edges; a first metal plate formed on the upper surface of the magnet; a second metal plate formed on the lower surface of the magnet; and a pair of wires connected to one of the first or second metal plates and any point at the edge of the magnet, the pair of wires capturing for use energy or power produced by the electric generator.

Preferably, the first metal plate is comprised of aluminum foil, and the second metal plate is comprised of aluminum foil.

An additional metal plate may be mounted over either of the first or second metal plates. The additional metal plate may be comprised of copper.

In one embodiment, the magnet comprises a series portions of alternating north and south polarities. One of the pair of wires may be connected to the first metal plate and the other of the pair of wires may be connected to a metal rod extending from an edge of the magnet. Any point on the edge of the magnet will produce different amounts of electricity which may not be related to that of the other edge points of the magnet.

Additionally, a diode may be provided in the wire extending from an edge of the magnet. A plurality of such electric generators are connected to each other, either in series, in parallel, or a combination thereof.

In one embodiment, the thickness of the magnet is approximately 15/256 inches. Further, the magnet may have dimensions which are approximately 1″×1″×0.11″.

In another form of the invention, a film is provided between the copper layer and either of the first metal plate or second metal plate to reduce deterioration of the metals.

According to a further aspect of the invention, there is provided a method of generating electricity comprising:

providing a substantially flat magnet having alternating north and south polarities, the magnet having upper and lower surfaces;
placing and aluminum layer over both the upper and lower surfaces of the magnet; placing an additional metal layer over at least one of the upper or lower surfaces to cover the aluminum layer; and capturing power or energy generated by the system by connecting wires across the electric generator.

Preferably, the additional metal layer is copper. A diode may be located in the wires to facilitate an increase in the amount of direct voltage and amperage generated by the system. Further, a plurality of such magnets may be joined in series, in parallel, or a combination of both.

Some background definitions and theories are set forth which may help explain the electric generator of the present invention.

A. Energy:

Energy is mass in motion (E=½M×V)

B. Mass Particles:

Mass particles are the smallest particles that are contained in our universe. The spatial size of a mass particle is three-dimensional. The volume of space a particle possesses is yet to be measured, but for the purposes of this description it is proposed to be finite and specific. The mass particle may have close to zero volume, although a mass particle may never in fact attain zero volume.

C. Charge:

Charge may be considered as comprising clusters of small mass particles (typically smaller than a Photon) that may move within wires.

D. Magnetic Field:

The directional movement of mass with respect to other mass in a counter parallel direction produces what we call the electromagnetic forces. The charge propagated down the current is the electric charge. The force that forms outside of the movement of charge, that is perpendicular to the direction of the flow of charge, is the magnetic field. The magnetic energy field that surrounds the directional current of electric charge is in fact mass particles in motion. These mass particles are much smaller than the particles of quarks, electrons or protons. Our technology permits us to detect the presence of particles up to a certain size.

E. Electrons do not move from one atom to another. Atomic clouds that surround atoms move from one atom to another one. Movement of the atomic clouds (mass particles) produce energy that can become electricity. The property and density of clouds dictate the shape of the material. With a change in temperature, density of the atomic clouds surrounding each atom will be reduced or increased. Therefore, material shapes change from vapor to liquid and to solid or the reverse thereof.

The magnetic storm has the ability to move atomic clouds (mass particles) from one atom to another. Reduction or excess of atomic clouds around an atom will make the atom unstable in the substance, and therefore atoms will try to balance their fields, and with that, the motion of atomic clouds (mass particle) will be detected in the field. The differential of mass clouds within atoms to atoms or substance to substance produce electricity.

The generator of the invention disclosed herein utilizes and capitalizes on the description set forth above.

The nature of a magnet is to provide directional movement of mass particles in the space field. This directional movement will affect any atoms that are located nearby, even though that might not be noticeable. The first effect is that the atomic clouds surrounding atoms will be disturbed, by either being moved from the atomic field, or by some more masses being added to the field. Atomic clouds (mass particles) that are attacked by this storm will move in the space in the same direction as that of the magnetic field. The stability of the shape of any atoms in a cluster as a substance mainly depend on the amount of clouds surrounding them. The thickness and concentration of the masses in the clouds will determine and dictate the substance shape. Therefore, atoms immediately try to fill the lost clouds by absorbing any particles existing in the surrounding field or other fields. These movements of mass particles in the field, by the definition of charge (see above), are considered to act as charge and provide Voltage in the system.

The electric generator of the present invention may be made from two (2) Aluminum Foils (Aluminum No. 1 and Aluminum No. 2), but also any other suitable metals in the table of elements that contains the fewest atoms (Si is one such example) can be used in place of the Aluminum foils. The Aluminum or other metal foils are attached on both sides of a Ferrite magnet, such as a Rubber Magnet of 1/16″ width and having north south portions connected to each other in an alternating fashion as shown in the drawings to be described below.

The thickness of the magnet as well as the strength of magnet has a large effect on the magnetite and on the voltage and the amperage of the system. Furthermore, the strength and thickness of metals will have a similar effect. The storm of mass particles produced by magnet will move mass particles from atomic clouds from the Aluminum (1) foil layer to the Aluminum (2) foil layer. This movement of masses starts the flow of mass particles in the system. After a few seconds, the flow will be mostly from the magnet to Aluminum (2) foil layer.

This movement of mass particles can be stopped or substantially reduced from exiting from the field by adding another metal from the table of elements with a higher group, to attach to the stronger end of the magnet over the Aluminum. One option used for the additional metal layer is that of an approximately 5/264″ Copper layer. Another option used for the additional metal layer is that of an approximately 0.027″ Copper layer. Variations in the thickness of such layer all within the scope of this invention. Elements with a higher group in the Table of Elements will be better elements to be used for the reduction of number of particles to be exited from the field. One example may comprise the use of lead (Pb). The use of rubber magnets that have North South next to each other, brings the highest storm within the field. As the distance between the north and south polarities of the magnet decreases, efficiency and output of the system increases.

By connecting wires to the copper, and to the neutral side of magnet as well, will produce a differential in charge (mass particles). Charges will flow within the system and this produces electricity. Because of north-south (N,S,N,S, as seen in the drawing) arrangement relative to each other in the magnet, the storm increases the flow. The voltage of the system has some differential depending on which natural side of magnet may be used for the second wire.

A diode may be installed in the system that reduces the two directional movements of charges inside the wire, and this will help to increase the amount of voltage and amperage in the system.

In one embodiment of the invention, the voltage obtained from each cell with Aluminum foil, with an overall dimension of 1″×1″×0.11″, is over 390 mil. volts DC and also at the same time measured around 50 mil. volts of AC. In another embodiment, made out of cells of Aluminum plates 1 and 2 with an Aluminum thickness of approximately 1/16″ and two layers of copper with the same thickness and the same magnet, almost the same voltage came out of this cell, but the AC voltage from the system was the same as DC voltage (390 mil. Volt.). The Amperage of the system with Aluminum foil was much bigger in number than the metal plates. Further, it has been observed that as the model gets larger or smaller in thickness and sizes, there will be not much of a change in output voltage. The smallest model in accordance with one embodiment of the invention was ½″×½″×0.11″ and the voltage detected was almost the same as some of the other ones described above, indicating that the size could be smaller with the same or similar output. By removing the Aluminum 1 from the system, the same voltage obtained, but it took a longer time before the voltage appears in the system.

Another embodiment in accordance with the present invention comprises one having dimensions of approximately ¼″×¼″, and it was found that the amperage dropped, possibly because the north south magnet was not provided for in that model. Each north or south of the magnet approximately 0.20″ and 0.25″ of model will not cover one cycle. The same experiment has been done with a ceramic Ferrite magnet, and the voltage was the same, but it took more time until voltage appears into the system. Further, the amperage was less than the other models.

In a further embodiment, the voltage obtained from each cell with Aluminum foil, with an overall dimension of 1″×1″×0.0505″ is over 520 mil. volts DC and also at the same time around 2 mil. volts of AC were measured. Another embodiment was comprised of cells of aluminum plates 1 and 2 with an aluminum thickness of 1/16″ and two layers of copper with the same thickness and the same magnet. Almost the same voltage came out of this cell, but the AC voltage from the system was, however, the same as DC voltage (520 mil. Volt). The Amperage of the system with aluminum foil was much bigger in number than the metal plates. By connecting a wire along the edge or another suitable location of a neutral magnet will produce more amperage. By connecting the wire and further adding another side to the magnet neutral, the amperage of the system will be doubled. If one more side is added to the neutral wire the amperage will be tripled and the same for the fourth side. Also, it is noted that as the model gets larger or smaller in thickness and sizes, there will be not much of a change in output voltage. The smallest model made was ½″×½″×0.189″, and the voltage was almost the same as the other ones described, indicating that the size could well be smaller with the same output with probably more amperage than the larger size.

Applying a film between the Aluminum (2) foil layer and the copper layer may reduce deterioration of the both metals.

The use of diodes will reduce the voltage of a system by approximately 0.7 V. By adding a diode to the system of one cell unit, the voltage of the system did not drop. The voltage maintained in the system is mostly due to converting portion of AC voltage to DC. Therefore if a diode added to the system of several cells, the voltage of the system will be much more than 400 mil. Volt multiplied by the number of cells. See FIG. 2 of the drawings.

The electric generator of the present invention has been tested by applying loads for period of weeks, but the voltage did not drop after removing the loads. Also after shorting wires for a period of days the same voltage has been measured. The life of the first built generator is over 10 months, and potentially over 18 months, with the same or more output of voltage being obtained. The life of this generator may be over 24 months, or even as much as 48 months. These tests showed that the system is generating electricity constantly. The estimated life could be related on the deterioration of the metals, or as a result of the magnet becoming weaker.

In order to increase voltage, or Amperage of these cells, they act like a battery. To increase voltage the cells should be connected in series and to increase amperage in parallel. The number of cells can be connected in parallel or in series, and after a certain number of cells the connection should be effected through diodes.

### BRIEF DESCRIPTION OF THE DRAWINGS

In the drawings:

FIG. 1 is a schematic view of an electric generator component in accordance with one aspect of the invention;

FIGS. 2 and 3 are a schematic representations of four and five such electric generators hooked together in series and in parallel respectively; and

FIG. 4 illustrates a series of cells connected together in parallel in accordance with an aspect of the invention.

### DETAILED DESCRIPTION OF THE INVENTION

Reference is now made to the accompanying drawings, which shows schematically the features and components of the electric generator in accordance with one aspect of the invention.

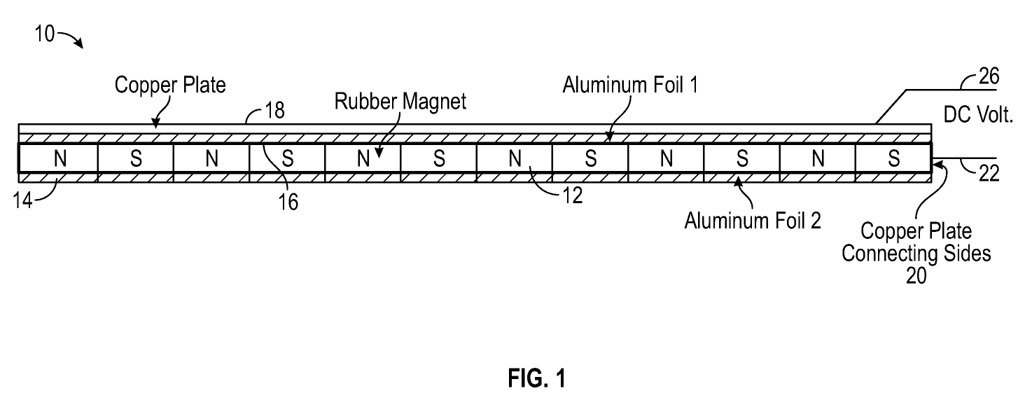

In FIG. 1 of the drawings, there is shown an electric generator component 10 generally comprised of a substantially flat magnet 12 having an alternating series of North and South polarities. The magnet 12 has a lower surface to which is attached a first aluminum foil strip layer 14, and an upper surface to which is attached a second aluminum foil strip layer 16. The magnet itself in the embodiment illustrated in this figure is approximately 15/256 inch thickness, one of the invention is not limited to such a thickness, and magnets of varying thickness according to the needs and parameters of the system may be used. Further, the magnet 12 is a rubber magnet, and may be flexible.

A copper plate layer 18 is mounted over the second aluminum foil strip layer 16. A terminal 20 extends from an image of the magnet 16, and a wire 22 is connected thereto. The wire 22 may include a diode 24. A further wire 26 is connected to the copper plate 18. The wires are used to harness the power and energy generated by the electric generator of the present invention.

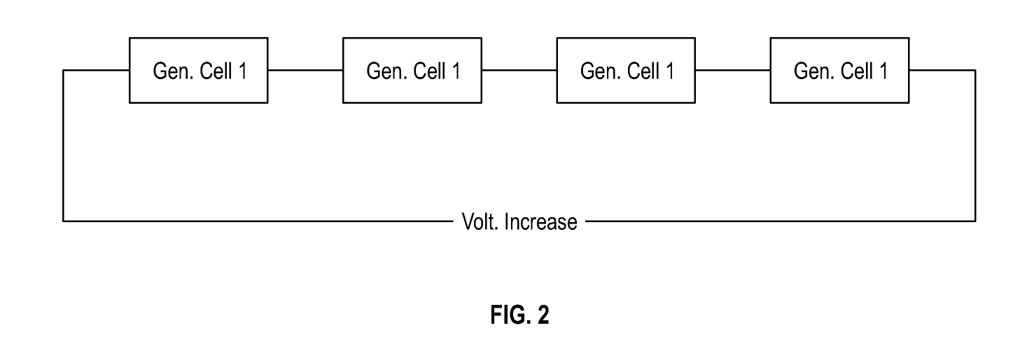

As shown in FIG. 2 of the drawings, a series of electric generators, which may be of the type illustrated in FIG. 1 of the drawings, or differently configured electric generators having different thicknesses and dimensions, may be connected together. FIG. 2 shows a series of four electric generators connected together, to exemplify the arrangement, but the invention is not limited to this number and any suitable number of electric generators may be joined. FIG. 2 of the drawings shows, separately, four electric generators which are joined in series, and four electric generators joined in parallel, each arrangement being optimal for generating voltage or amperage, as discussed above.

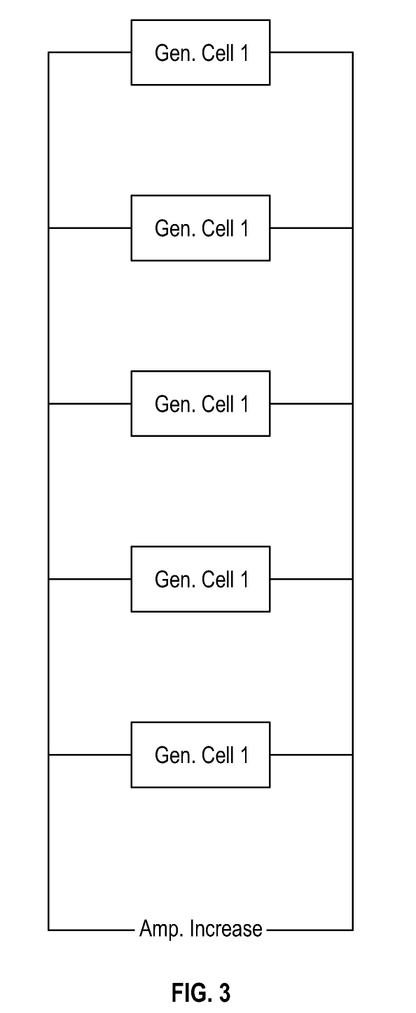

FIG. 3 of the drawings illustrates a series of cells in parallel.

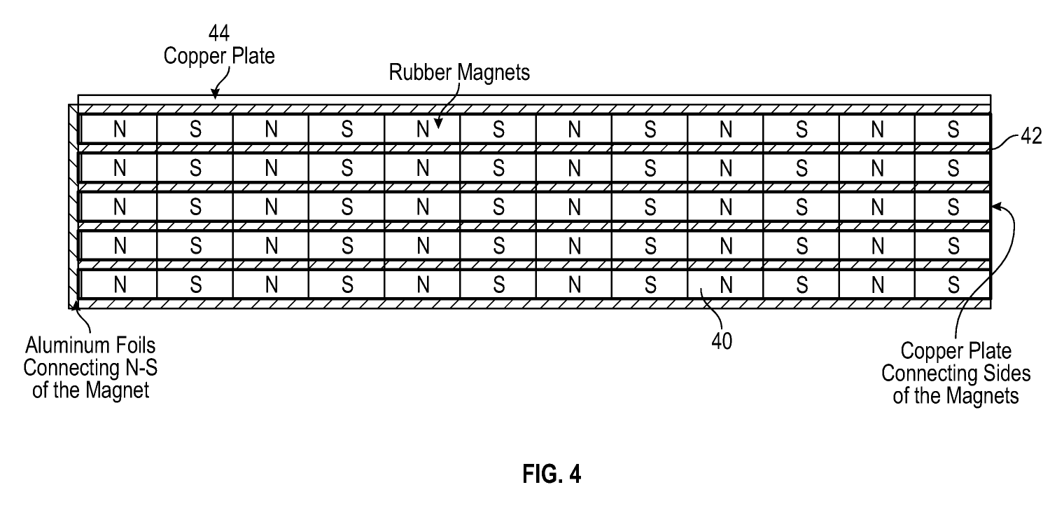

FIG. 4 of the drawings illustrates a further embodiment of the invention comprising a series of stacked magnets 40 each having alternating north and south polarities. As will be noted, the north polarity of each magnet is above and below the north polarity of an adjacent magnet, and the same applies to the south polarities. A copper plate 42 connects the side of the magnets 40. Further, a copper plate 44 is mounted on the top magnet in the stack. Aluminum foils are also provided, and extend between each one of the magnets in the stack, as well as on one side of the stack. The aluminum foils are also located below the lowest rubber magnet 40, and between the top rubber magnet 40 and the copper plate 42. The embodiment of the invention illustrated in this figure of the drawings may be connected as described with reference to other embodiments of the invention above. It is to be noted that, while five stacks of rubber magnets 40 are shown in FIG. 4 of the drawings, other numbers of stacked magnets can be used. In addition, each rubber magnet in the stack need not be of identical length. Further, the aluminum foils may be located between or adjacent the magnets in other different configurations. The copper plate 42 may also be attached in a different location.

1. An electric generator comprising:
a substantially flat magnet having a series of alternating north and south polarities, the magnet having an upper surface, a lower surface and opposing edges;
a first metal plate formed on the upper surface of the magnet;
a second metal plate formed on the lower surface of the magnet; and
a pair of wires connected to one of the first or second metal plates and an edge of the magnet, the pair of wires capturing for use energy or power produced by the electric generator.

2. An electric generator as claimed in claim 1 wherein the first metal plate is comprised of aluminum foil.

3. An electric generator as claimed in claim 1 wherein the second metal plate is comprised of aluminum foil.

4. An electric generator as claimed in claim 1 further comprising an additional metal plate mounted over either of the first or second metal plates.

5. An electric generator as claimed in claim 4 wherein the additional metal plate is comprised of copper.

6. An electric generator as claimed in claim 1 wherein the magnet comprises a series portions of alternating north and south polarities.

7. An electric generator as claimed in claim 1 wherein one of the pair of wires is connected to the first metal plate and the other of the pair of wires is connected to a metal rod extending from an edge of the magnet.

8. An electric generator as claimed in claim 1 further comprising a diode in the wire extending from an edge of the magnet.

9. An electric generator as claimed in claim 1 wherein a plurality of such electric generators are connected to each other.

10. An electric generator as claimed in claim 9 wherein the plurality of electric generators are connected to each other in series.

11. An electric generator as claimed in claim 9 wherein the plurality of electric generators are connected to each other in parallel.

12. An electric generator as claimed in claim 1 wherein the thickness of the magnet is approximately 15/256 inches.

13. An electric generator as claimed in claim 1 wherein the magnet as dimensions which are approximately 1″×1″×0.11″.

14. An electric generator as claimed in claim 1 which is capable of generating both alternating current (AC) and direct current (DC).

15. An electric generator as claimed in claim 5 further comprising a film between the copper layer and either of the first metal plate or second metal plate to reduce deterioration of the metals.

16. A method of generating electricity comprising:
providing a substantially flat magnet having alternating north and south polarities, the magnet having upper and lower surfaces;
placing and aluminum layer over both the upper and lower surfaces of the magnet;
placing an additional metal layer over at least one of the upper or lower surfaces to cover the aluminum layer; and
capturing power or energy generated by the system by connecting wires across the electric generator.

17. A method as claimed in claim 16 further wherein the additional metal layer is copper.

18. A method as claimed in claim 17 further comprising locating a diode in the wires to facilitate an increase in the amount of voltage and amperage generated by the system.

19. A method as claimed in claim 18 comprising the step of joining a plurality of magnets in series or parallel.
